(19) United States
(12) Patent Application Publication
(10) Pub. No.: US 2015/0299596 A1
(43) Pub. Date: Oct. 22, 2015

(54) METHODS FOR REMOVING CONTAMINANTS FROM NATURAL GAS

(71) Applicants: Rustam H. Sethna, Clinton, NJ (US); Gary Peterson, Easton, PA (US); John Lindberg, Tarrytown, NY (US)

(72) Inventors: Rustam H. Sethna, Clinton, NJ (US); Gary Peterson, Easton, PA (US); John Lindberg, Tarrytown, NY (US)

(21) Appl. No.: 14/626,972

(22) Filed: Feb. 20, 2015

Related U.S. Application Data
(60) Provisional application No. 61/951,668, filed on Mar. 12, 2014.

(51) Int. Cl. C10L 3/10; B01D 53/22

(52) U.S. Cl. CPC C10L 3/104; B01D 53/226; B01D 53/228; B01D 53/229; C10L 3/106; C10L 3/101; C10L 3/103; B01D 2053/221; C10L 2290/548

(57) ABSTRACT

A method for removing contaminants from a natural gas feed stream from a well head is provided for. The natural gas feed stream is fed to a separation unit which contains a first gas membrane unit for removing hydrocarbons and a second gas membrane unit for removing carbon dioxide from the natural gas feed stream. The method allows the same unit to be used for either hydrocarbon conditioning of field gas for drilling operations (power generation) and/or for pipeline quality natural gas production from wells.

### CROSS REFERENCE TO RELATED APPLICATIONS

This application claims priority from U.S. provisional patent application 61/951,668 filed Mar. 12, 2014.

### BACKGROUND OF THE INVENTION

The invention relates to the use of membranes to purify natural gas. In particular, the present invention relates to the use of two membrane units for removing hydrocarbons and carbon dioxide from the natural gas stream recovered from the well head of a fraccing operation. The carbon dioxide content can be reduced to below 2 mole percent of the natural gas making the natural gas pipeline quality. In addition, the water content is reduced to a level far lower than typical pipeline specification of <7 pounds of water vapor per mullion cubic feet.

Natural gas is known to be extracted from underground reservoirs. The natural gas will often contain nitrogen and oxygen and other hydrocarbon gases that are considered impurities. These unwanted gases could be naturally occurring or the result of a process like nitrogen injection into the reservoir as part of an enhanced oil recovery.

Earlier processes have attempted the removal of these contaminant gases from natural gas. For example, a pressure swing adsorption (PSA) process separates hydrogen from natural gas by two separate PSA stages, the first stage for nitrogen and the second stage for hydrogen. Alternatively a PSA process is employed which utilizes two separate PSA stages. The first stage removes hydrocarbons from the natural gas and the second stage removes nitrogen. In a different approach, methane is recovered from crude natural gas and solid waste landfill exhaust gas by a sequential operation of a PSA step to remove volatile organic compounds. This stream is fed to a membrane system whereby carbon dioxide is removed from the natural gas stream.

The present invention utilizes two gas membrane units in conjunction for removing hydrocarbons and carbon dioxide from a natural gas feed stream. Typically this natural gas feed stream is from a well head that has been subjected to a fraccing operation.

### SUMMARY OF THE INVENTION

In one embodiment of the invention, there is disclosed a method for purifying natural gas from a gas mixture containing natural gas and contaminants comprising feeding the gas mixture to a first membrane separation unit and then feeding the gas mixture to a second membrane separation unit.

Typically the contaminants will comprise carbon dioxide and hydrocarbons. The hydrocarbons can include ethane, butane and propane. Other contaminants such as hydrogen sulfide may also be present.

The natural gas that may be purified may be from any typical natural gas source such as from an underground reservoir or through a wellhead.

An optional additional step in the method is to remove liquid from the gas mixture by a coalescing filter prior to feeding the gas mixture to the first membrane separation unit. Typically this liquid is water.

The hydrocarbons are removed from the gas mixture by the first membrane separation unit and the carbon dioxide is removed from the gas mixture by the second membrane separation unit.

Both the first and the second membrane separation units may use polyether ether ketone (PEEK) membranes which is preferred because of their high chemical resilience to hydrocarbons and other contaminants.

The contaminants from the first membrane separation unit and the second membrane separation unit are recovered in a low pressure permeate waste gas header.

The contaminants are recovered in at least one waste drum prior to the contaminants being destroyed. Alternatively, the contaminants are recovered and employed as a fuel for an internal combustion engine.

In another embodiment, a slipstream of the gas mixture is created and this slipstream is mixed with the gas mixture recovered from the first membrane separation unit and the gas mixture recovered from the second membrane separation unit to form a product gas mixture. This product gas mixture is collected in a high pressure gas header.

The composition of the product gas mixture is measured by an analyzer selected from the group consisting of a hydrocarbon dew point analyzer and a carbon dioxide analyzer. Based upon these analyses, the recovered contaminants may be mixed with the product gas mixture.

Two or more waste drums are used to mix the recovered contaminants together. The mixed recovered contaminants can be fed from the two or more waste drums to the product gas mixture:

The reduction of flare gas from a well head serves both an environmental need in terms of reduced hydrocarbon emissions and a business need in terms of making more saleable natural gas. This is particularly applicable when the well has been fractured using carbon dioxide or water as the primary fracturing fluid. Depending upon the composition of the shale gas or the fracturing fluids used, the effluent from the well may contain high concentrations of carbon dioxide, hydrogen sulfide, ethane, butane, propane, etc. The present invention improves the quality of the shale gas by removing carbon dioxide, other hydrocarbons and other impurities such as hydrogen sulfide from the feedstock thereby rendering the natural gas saleable as pipeline quality gas and avoiding flaring of the gas as a disposal means.

Field gas conditioning where the untreated or conditioned well head natural gas can be used to operate the high horsepower engines or turbines used in the oil fields is another application. If an engine has been converted to allow it to run on both diesel and natural gas (by-fuel) or it is a dedicated engine/turbine built for natural gas combustion alone, it is a candidate for field gas. Many mid stream operators and oil field service companies can use the engines that operate on this fuel to power their equipment. The problem facing untreated field gas is that its characteristics, like the underlying natural gas stream composition and BTU value, can change from well to well which can prohibit its use as a fuel or affect engine performance.

The present invention can reject carbon dioxide from frac gas having a high carbon dioxide content. The same unit can further be used for natural gas hydrocarbon dew point/heating value control for remote drilling applications. The hydrocarbon dew point needs to be controlled as natural gas from well heads will typically contain a number of liquid hydrocarbon components. The heavier components present will tend to condense first and will define the hydrocarbon dew point temperature of the gas mixture. Removal of the heavier hydrocarbon components will reduce the hydrocarbon dew point which will result in a natural gas mixture that will flow better but will also approach the composition of a pipeline quality gas.

As such, two varieties of membranes are used in the present invention in conjunction with each other to provide removal of the hydrocarbons in the natural gas which can raise the natural gas feed stream's dew point and carbon dioxide which can lower the value of the resultant natural gas stream containing elevated amounts of carbon dioxide.

The use of the present invention will result in less upstream cleanup due to the removal of the various contaminants by the process.

Polyether ether ketone (PEEK) membranes may be employed in both gas membrane units.

The waste gas from the well can still be flared but in a more environmentally responsible manner or utilized for power generation. Alternatively, the low pressure waste gas stream/condensate can be used to gradually blend back into the product gas when the feed gas quality is high enough.

The method for purifying natural gas may be deployed to a frac site for carbon dioxide removal for pipeline gas supply or to a drilling site for field gas hydrocarbon conditioning/heating value control. The dual purpose allows the method to be deployed and on-stream for longer periods of time providing thereby more value to the end user.

### BRIEF DESCRIPTION OF THE DRAWINGS

FIG. 1 is a schematic showing the two membrane separation units.

FIG. 2 is a schematic according to FIG. 1 wherein the destination of the treated natural gas is a stack/flare.

FIG. 3 is a schematic according to FIG. 1 wherein the destination of the treated natural gas is an engine.

FIG. 4 is a schematic showing the two membrane separation systems with a single waste drum.

FIG. 5 is a schematic showing the two membrane separation systems with two waste drums.

### DETAILED DESCRIPTION OF THE INVENTION

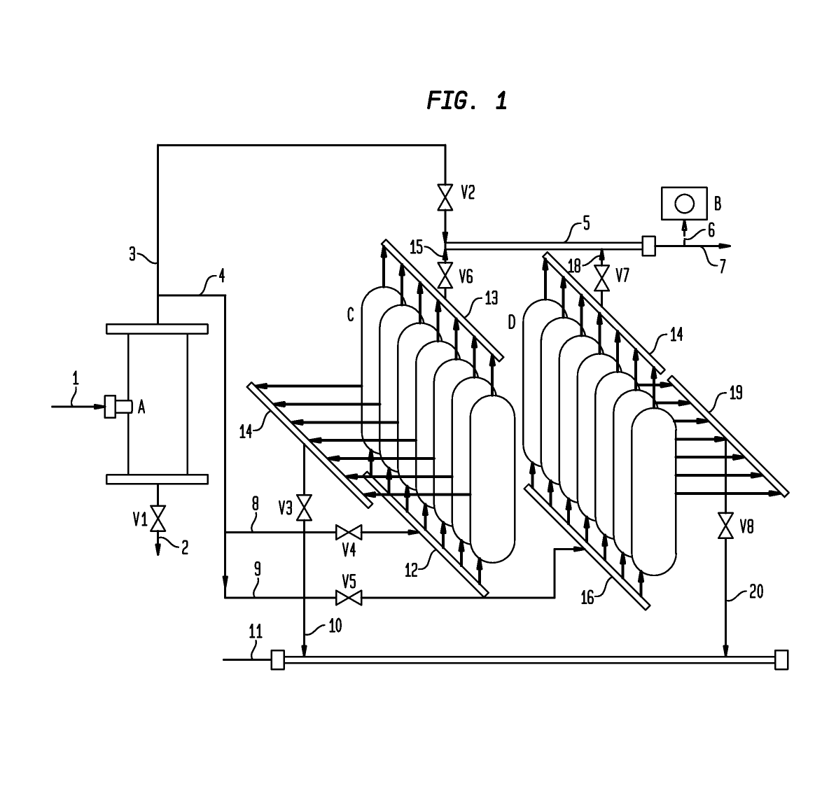

FIG. 1 is a schematic of a method to remove contaminants from a natural gas mixture. A raw pipeline feed gas consisting of natural gas plus contaminants such as carbon dioxide, hydrogen sulfide, ethane, butane, propane and trace contaminants is fed through line 1 to a coalescing filter A. The coalescing filter A will separate out any liquids present in the feed gas and remove them from the system through open valve V1 and line 2. The feed gas will exit the coalescing filter A through line 3 and be fed through valve V2 to line 5 where the feed gas is held in storage. This portion of the feed gas stream will be fed through line 6 to a hydrocarbon dew point analyzer B which will measure hydrocarbon content of the feed gas mixture and once analyzed will be fed out of the system through line 7 as a high pressure raffinate product gas and recovered.

A portion of the feed gas stream will be diverted from line 3 through line 4 which will firstly feed line 8 and through open valve V4 will enter though line 12 a first gas membrane unit C

The membranes employed in the gas membrane unit may be for example polyether ether ketone (PEEK) membranes. Alternatively, silicone rubber membranes/spiral-wound membrane modules may be employed.

For purposes of illustration, seven membrane components are shown but are considered as one membrane unit through which the feed gas mixture enters through line 12. The gas membrane unit C will remove various hydrocarbon impurities from the feed gas mixture resulting in a purified feed gas mixture that is primarily natural gas and carbon dioxide with reduced levels of the other hydrocarbons present therein. The hydrocarbon impurities are directed from the gas membrane unit C through line 14 and open valve V3 where they will enter the low pressure gas header 10. Low pressure permeate waste gas can then be released through line 11 and captured for further treatment or released to enter the atmosphere in an environmentally correct manner.

The purified feed gas mixture will exit the gas membrane unit C through line 13 and open valve V6 where it will enter through line 15 to line 5 where it will rejoin the portion of feed gas mixture not treated by the gas membrane unit C. This combination of untreated and treated feed gas mixture will also be analyzed by feeding a portion of the mixture through line 6 to the hydrocarbon dew point analyzer B before it is captured through line 7 as high pressure raffinate product gas and stored and/or used.

A portion of the feed gas mixture from line 4 will bypass line 8 and be fed to line 9. Typically, valve V4 would be closed and valve V5 would be open to allow the feed gas mixture to enter through line 16 a carbon dioxide rejection membrane unit D. Likewise for the carbon dioxide rejection membrane unit D, seven membrane components are shown but treated as one membrane unit for purposes of description.

This feed gas mixture stream will still contain the impurities as well as the carbon dioxide and natural gas. The carbon dioxide rejection membranes will separate carbon dioxide which will be removed from the carbon dioxide rejection membrane unit D through line 19 and open valve V8 where it will be fed to line 20 and into the low pressure gas header 10 where it will join in with the low pressure permeate waste gas for further treatment or disposal into the atmosphere.

The treated feed gas mixture that is now free of carbon dioxide will be directed through line 14 and open valve V7 through line 18 to line 5 where it will join in with the original feed gas mixture and the feed gas mixture treated for the hydrocarbon impurities from the gas membrane unit C, After analysis by the hydrocarbon dew point analyzer, the entirety of the product mixture is recovered as high pressure raffinate product gas.

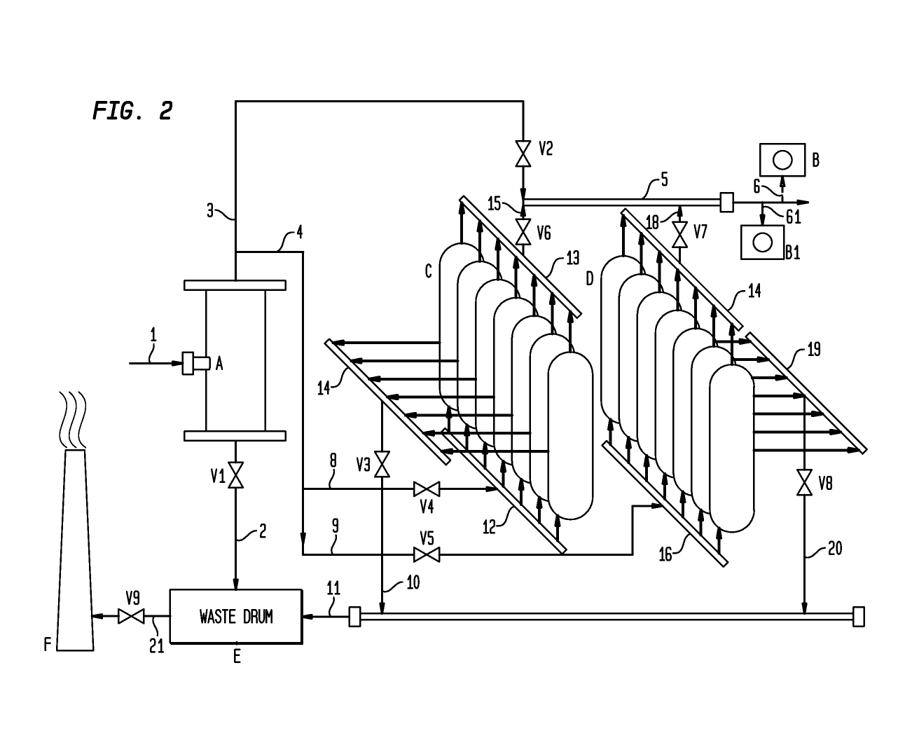

FIG. 2 represents a situation where a waste drum is employed in the process for removing contaminants from the feed gas mixture. For purposes of describing FIG. 2, the same numbering scheme will be used as for FIG. 1 with the description of the waste drum added.

The condensate from the coalescing filter A will as noted be fed through open valve V1 and line 2 to a waste drum E. Waste drum E will also receive through line 11 the low pressure permeate waste gas header. The waste drum E will accumulate these impurities from the gas membrane units C and D and the coalescing filter A and will periodically discharge them through line 21 and open valve V9 to a stack or flare F where the impurities will be burned forming carbon dioxide and water for release to the atmosphere.

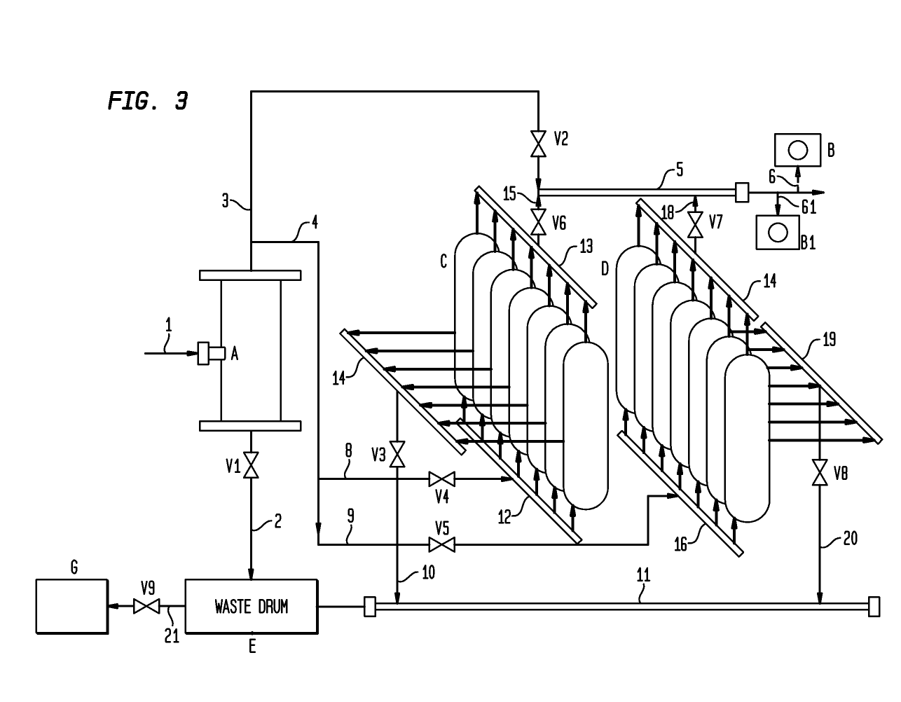

FIG. 3 depicts a variant operation from FIGS. 1 and 2 where contaminants are removed from the feed gas stream mixture. For purposes of describing FIG. 3, the same numbering scheme will be used as for FIG. 1. Rather than feed the accumulated impurities from the waste drum E to a stack or flare, these impurities are periodically fed through line 21 and open valve V9 to an internal combustion engine G which can be powered by the hydrocarbons present in the impurities. The internal combustion engine G may be employed in operating equipment or providing another source of power to the industrial operation.

Additionally, a carbon dioxide analyzer is employed in the embodiment depicted by FIG. 3. Per FIG. 1, the totality of treated (both for hydrocarbons and carbon dioxide) plus original feed gas mixture is present in line 5 and is fed through line 6 to a hydrocarbon dew point analyzer B before being captured as a high pressure raffinate product gas. In this embodiment, a portion of the mixture of treated and untreated feed gas is directed through line 61 to a carbon dioxide analyzer B1 where the amount of carbon dioxide present in the mixture is determined.

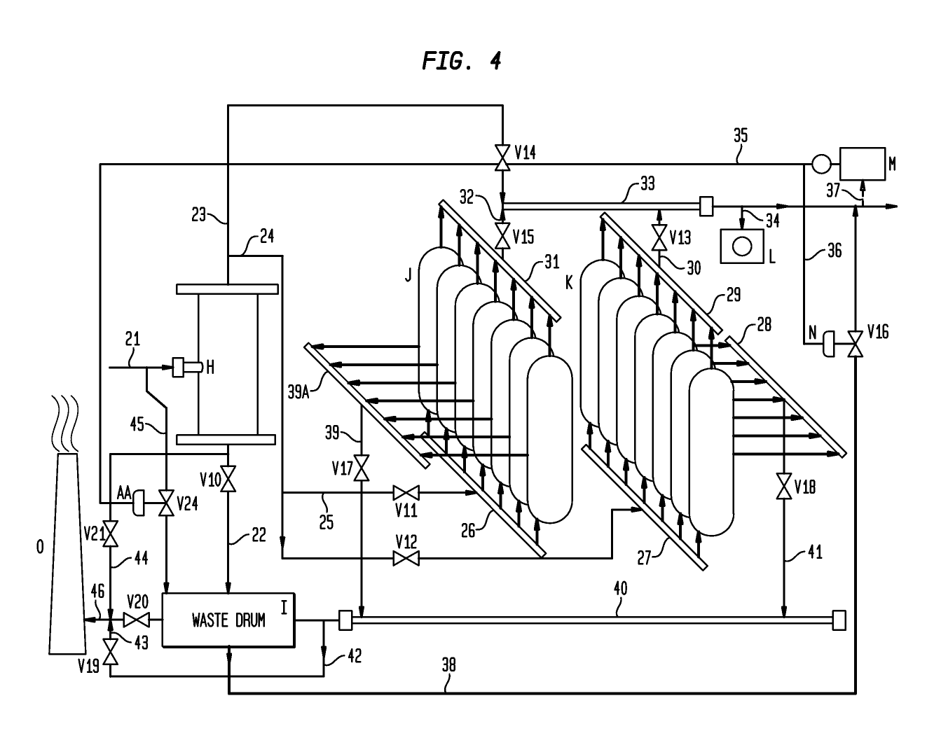

FIG. 4 depicts schematically a process for removing contaminants from a natural gas mixture where blending in a single waste drum occurs. A feed gas mixture such as from a raw pipeline feed gas is fed through line 21 to a coalescing filter H. There liquids present in the feed gas mixture will coalesce and be removed from the coalescing filter H.

The feed gas mixture now essentially free of liquids is fed through line 23 from the coalescing filter H through open valve V14 to line 33 where it is held in storage.

A portion of the feed gas mixture will be diverted through line 24 where it will be further diverted through line 25 and open valve V11 to a gas membrane unit J. For purposes of illustration, seven membrane components are shown but are considered as one gas membrane unit through which the fed gas mixture enters through line 26. The gas membrane unit C will remove various hydrocarbon impurities from the feed gas mixture resulting in a purified feed gas mixture that is primarily natural gas and carbon dioxide. The hydrocarbon impurities are directed from the gas membrane unit J through line 39 and through line 39A and open valve V17 where they will enter the low pressure gas header 40.

The feed gas mixture which will be essentially free of hydrocarbon impurities will exit the gas membrane unit J through line 31 and open valve V15 where it will join the untreated feed gas mixture in line 33.

The portion of the feed gas stream mixture not diverted through line 25 will continue with valve V11 closed and valve V12 open through line 5 to line 27 where it will enter the carbon dioxide rejection membrane unit K. For purposes of illustration, seven membrane components are shown but are considered as one carbon dioxide rejection membrane unit. The membranes will separate carbon dioxide from the hydrocarbons and natural gas present in the feed gas mixture. The carbon dioxide will be fed through line 28 out of the carbon dioxide rejection membrane unit K through open valve V18 to line 41 where it will join with the hydrocarbons separated from the gas membrane unit J in line 40,

The feed gas mixture which is free of carbon dioxide will exit the carbon dioxide rejection membrane unit K through line 29. Open valve V13 will allow its passage through line 30 to line 33 where it will join with the purified stream from the gas membrane unit J and the untreated feed gas mixture. The combined mixture of these three streams will be diverted in part through line 34 to a carbon dioxide analyzer L for determination of the amount of carbon dioxide present in the combined feed gas mixture stream. This combined feed gas mixture stream will be recovered through line 33 as a high pressure conditioned raffinate product gas. Likewise a portion of this combined feed gas stream mixture is diverted through line 37 to a hydrocarbon dew point analyzer M which will determine concentration of liquefied natural gas present in the combined gas mixture.

The hydrocarbon dew point analyzer M will send a signal via line 35 to a three way valve AA. This three way valve AA will determine if valve V21A which is connected to the raw pipeline feed gas input 21 through line 45 is to be opened to allow a portion of the feed gas mixture to be fed to the waste drum I.

The condensate from the coalescing filter will be fed through open valve V10 and line 22 to the waste drum I. A portion of this coalesced liquid is diverted through line 44 and open valve (valve V10 being closed) V21 to line 46 where it may be fed to the stack or flare O where the impurities will be burned forming carbon dioxide and water for release to the atmosphere,

The combined contaminants that are recovered in line 40 from the two gas membrane units J and K are fed to the waste drum I. A portion of this feed may be diverted through line 42 and open valve V19 through line 43 to line 46 which feeds directly to the stack or flare O. Primarily this feed of combined contaminants will enter the waste drum I through line 40 and be combined with the coalesced liquid from the coalescing filter H. These combined waste products will exit the waste drum I through open valve V20 and enter through line 46, alone, or with the diverted liquid from line 44 or part of the combined contaminants from line 43 the stack or flare O for combustion and destruction.

The hydrocarbon dew point analyzer will also send a signal through line 36 to a three way valve N which is in fluid communication with valve V16. Depending upon the analysis of the high pressure conditioned raffinate product gas stream in line 33, a portion of the combined contaminants from the waste drum I will be fed through line 38 and open valve V16 for joining with the high pressure conditioned raffinate product gas stream for recovery by the operator of the system.

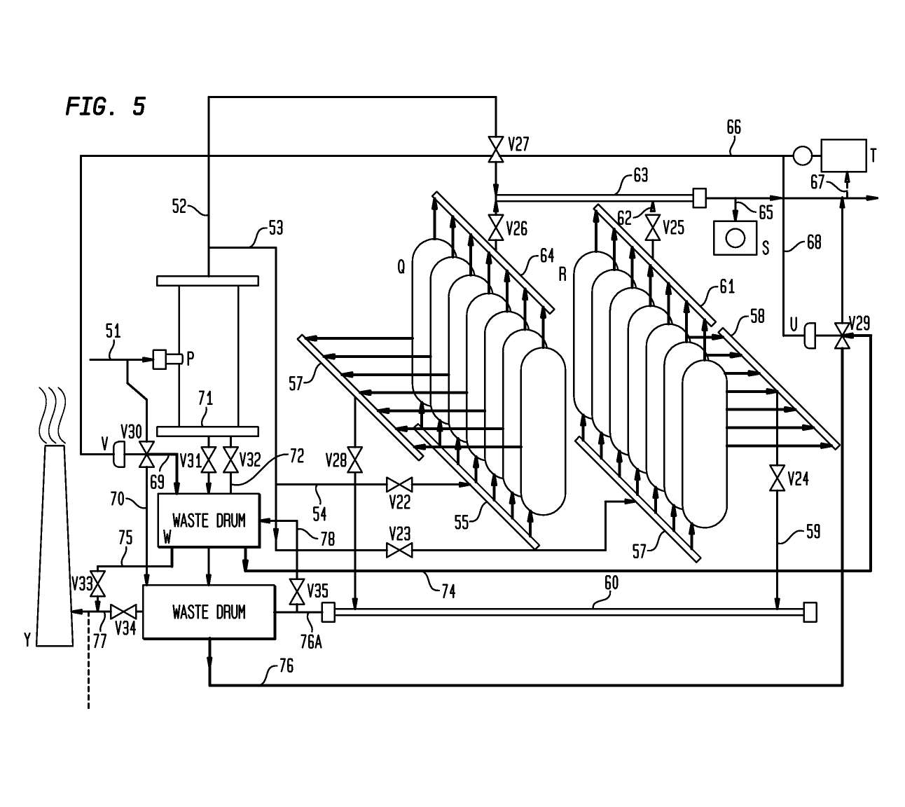

FIG. 5 depicts the removal of contaminants from a feed gas mixture where two waste drums are employed. A natural gas feed gas mixture such as that from a raw pipeline is fed to a coalescing filter P through line 51. The resultant gas stream free of liquids is fed through line 52 through open valve V27 to line 63 where it is held in storage.

A portion of the feed gas mixture is diverted from line 52 by closing valve V27 and opening valve V22. The feed gas mixture is thus diverted through line 53 to line 55 of the gas membrane unit Q. For purposes of illustration, seven membrane components are shown but are considered as one membrane unit through which the feed gas mixture enters through line 55. The gas membrane unit Q will remove various hydrocarbon impurities from the feed gas mixture resulting in a purified feed gas mixture that is primarily natural gas and carbon dioxide. The hydrocarbon impurities are directed from the gas membrane unit Q. through line 57 and open valve V28 where they will enter the low pressure gas header 60.

The feed gas mixture which will be essentially free of hydrocarbon impurities will exit the gas membrane unit Q through line 64 and open valve V26 where it will join the untreated feed gas mixture in line 63.

The portion of the feed gas stream mixture not diverted through line 54 will continue with valves V27 and V22 closed and valve V23 open through line 53 to line 57 where it will enter the carbon dioxide rejection membrane unit R. For purposes of illustration, seven membrane components are shown but are considered as one carbon dioxide rejection membrane unit. The membranes will separate carbon dioxide from the hydrocarbons and natural gas present in the feed gas mixture. The carbon dioxide will be fed through line 58 out of the carbon dioxide rejection membrane unit R through open valve V24 to line 59 where it will join with the hydrocarbons separated from the gas membrane unit Q in line 60.

The feed gas mixture which is free of carbon dioxide will exit the carbon dioxide rejection membrane unit Q through line 61. Open valve V25 will allow its passage through line 62 to line 63 where it will join with the purified stream from the gas membrane unit Q and the untreated feed gas mixture from the coalescing filter P. The combined mixture of these three streams will be diverted in part through line 65 to a carbon dioxide analyzer S for determination of the amount of carbon dioxide present in the combined feed gas mixture stream. This combined feed gas mixture stream will be recovered through line 63 as a high pressure conditioned raffinate product gas. Likewise a portion of this combined feed gas stream mixture is diverted through line 67 to a hydrocarbon dew point analyzer T which will determine concentration of liquefied natural gas present in the combined gas mixture.

A portion of the coalesced liquids from the coalescing filter P will exit through line 71 and open valve V31 to waste drum W. Another portion of the coalesced liquids will exit the coalescing filter P through line 72 and open valve V32 to waste drum X.

A portion of the feed gas mixture will be diverted from line 51 through line 70 and fed through open valve V30 to the waste drum X. The hydrocarbon dew point analyzer T will send a signal through line 66 to the three way valve V which is fluidly connected to valve V30. This will allow based upon the reading of the hydrocarbon dew point analyzer T to allow for a diversion of the feed gas mixture from line 51 through valve V30 and line 69 directly to waste drum W.

The combined contaminants from the two membrane units Q and R that have been fed to line 60 will fed through open valve V35 and line 78 to the waste drum W. Alternatively, valve V35 remains closed and these contaminants are fed through line 76A to waste drum X.

The hydrocarbon dew point analyzer T will also send a signal through line 68 to a three way valve U which is fluidly connected to valve V29. Valve V29 can be opened and some of the contaminants from waste drum W can be fed through line 74 to connect with line 63 in order to supplement the high pressure conditioned raffinate product gas with hydrocarbons or carbon dioxide removed from the feed gas mixture depending upon the needs of the product gas stream.

Alternatively the contaminants from waste drum W may be fed through line 75 and open valve V33 to line 77 which conducts them to the stack or flare Y where they may be incinerated and destroyed. This may be performed in conjunction with open valve V34 which will accept into line 77 the contaminants from waste drum X for feed to the stack or flare Y.

The operation of the two membrane units operates in the same fashion as otherwise described with respect to FIG. 1. While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method for purifying natural gas from a gas mixture containing natural gas and contaminants comprising feeding the gas mixture to a first membrane separation unit and then feeding the gas mixture to a second membrane separation unit.

2. The method as claimed in claim 1 wherein the contaminants comprise water, carbon dioxide and hydrocarbons.

3. The method as claimed in claim 2 wherein the contaminants comprises water, carbon dioxide, hydrogen sulfide, ethane, butane, and propane.

4. The method as claimed in claim 1 wherein the natural gas is from an underground reservoir.

5. The method as claimed in claim 1 further comprising removing liquid from the gas mixture by a coalescing filter prior to feeding the gas mixture to the first membrane separation unit.

6. The method as claimed in claim 5 wherein the liquid is water.

7. The method as claimed in claim 2 wherein the hydrocarbons are removed from the gas mixture by the first membrane separation unit.

8. The method as clamed in claim 2 wherein the carbon dioxide is removed from the gas mixture by the second membrane separation unit.

9. The method as claimed in claim 1 wherein the first membrane separation unit and the second membrane separation unit are polyether ether ketone membranes.

10. The method as claimed in claim 1 wherein the contaminants from the first membrane separation unit and the second membrane separation unit are recovered in a low pressure permeate waste gas header, thereby obviating the need for a pre-purifier guard bed and feed gas heating.

11. The method as claimed in claim 1 wherein the contaminants are recovered in at least one waste drum prior to the contaminants being destroyed.

12. The method as claimed in claim 1 wherein the contaminants are recovered and employed as a fuel for an internal combustion engine.

13. The method as claimed in claim 1 further comprising creating a slipstream of the gas mixture and mixing the gas mixture with the gas mixture recovered from the first membrane separation unit and the gas mixture recovered from the second membrane separation unit, thereby forming a product gas mixture.

14. The method as claimed in claim 13 wherein the product gas mixture is collected in a high pressure gas header.

15. The method as claimed in claim 13 wherein the composition of the product gas mixture is measured by an analyzer selected from the group consisting of a hydrocarbon dew point analyzer and a carbon dioxide analyzer.

16. The method as claimed in claim 10 wherein the recovered contaminants are mixed with the product gas mixture.

17. The method as claimed in claim 16 wherein two or more waste drums are used to mix the recovered contaminants together.

18. The method as claimed in claim 17 wherein the mixed recovered contaminants are fed from the two or more waste drums to the product gas mixture.

19. The method as claimed in claim 1 wherein purifying natural gas is performed at a frac site.

20. The method as claimed in claim 1 wherein purifying natural gas is performed at a drilling site.
